(19) United States
(12) Patent Application Publication
(10) Pub. No.: US 2016/0159267 A1
(43) Pub. Date: Jun. 9, 2016

(54) FAST FILL CNG MOBILE TRANSPORTER

(71) Applicant: Steve Dixon, Denison, TX (US)

(72) Inventor: Steve Dixon, Denison, TX (US)

(21) Appl. No.: 14/562,666

(22) Filed: Dec. 6, 2014

(51) Int. Cl. B60P 3/22; B60P 3/24

(52) U.S. Cl. CPC B60P 3/225; B60P 3/228; B60P 3/24; B60P 3/2215

(57) ABSTRACT

A transporter to transport compressed natural gas may include a plurality of storage tubes being positioned in a storage rack, and a frame to hold the storage tubes, at least one composite covering to cover the transporter and a pumping unit to pump the compressed natural gas.

### FIELD OF THE INVENTION

The present invention relates to a transporter for compressed natural gas and more particularly for a transporter to dispense the compressed natural gas.

### BACKGROUND

Natural gas is an abundant, reliable and cleaner-burning fuel than both gasoline and diesel for consumer and commercial vehicles. For fleet owners in particular (including everything from taxis and transit buses to long-haul semi trailers), compressed natural gas CNG presents an opportunity to dramatically reduce fuel costs and make an immediate, direct, positive impact on the bottom line.

### SUMMARY

A transporter to transport compressed natural gas may include a plurality of storage tubes being positioned in a storage rack, and a frame to hold the storage tubes, at least one composite covering to cover the transporter and a pumping unit to pump the compressed natural gas.

The transporter may include buffer tanks to connect to the pumping unit.

The transporter may include emergency lights.

The transporter may include at least one camera.

The transporter may include a hydraulically operated door.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the transporter of the present invention;

FIG. 2 illustrates a perspective view of the transporter of the present invention;

FIG. 3 illustrates a perspective view of the transporter of the present invention;

FIG. 4 illustrates a perspective view of the transporter of the present invention;

FIG. 5 illustrates a perspective view of the transporter of the present invention;

FIG. 6 illustrates a perspective view of the transporter of the present invention;

FIG. 7 illustrates an perspective view of the transporter of the present invention.

### DETAILED DESCRIPTION

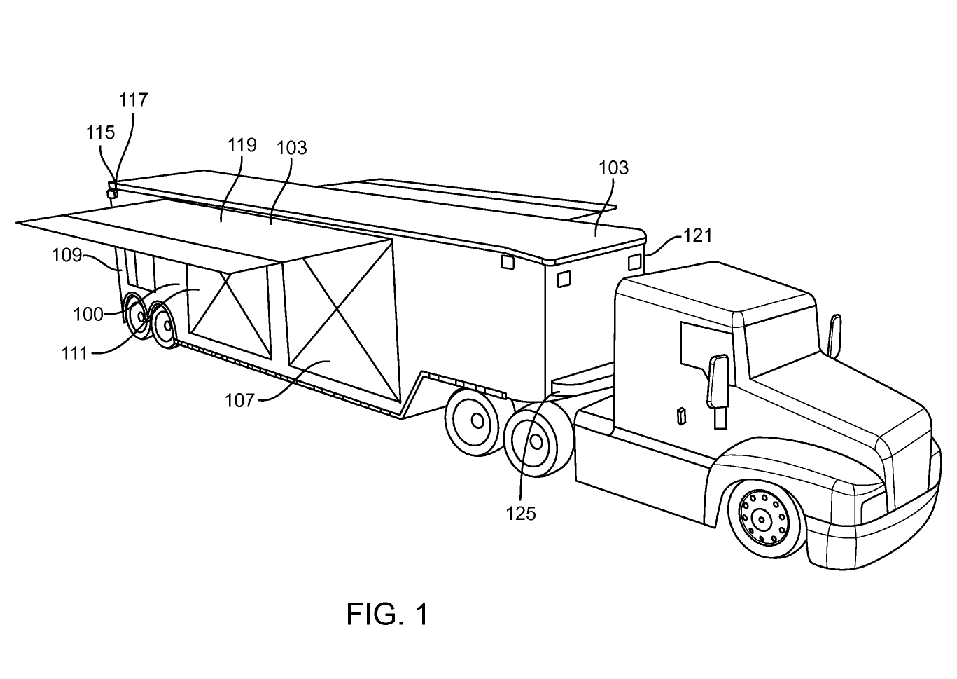

FIG. 1 illustrates a perspective view of the transporter 100 of the present invention, and the transporter 100 may be a trailer being towed by a tractor trailer. The transporter 100 may be formed from composite panels 103 which may include the top panel/roof and may include doors 119 which may form the sides and back of the transporter 100. An additional composite panel 103 may include the front panel of the transporter 100. The transporter 100 may transport compressed natural gas in tube tanks 107 which may be stacked in a frame 113. The tube tanks 107 may be stacked vertically and horizontally in order to provide an efficient packing of the tube tanks 107.

Additionally, the transporter 100 may include emergency lights 115 and cameras 117 which may be used to provide security. Additionally, the transporter 100 may include doors 119 which may be positioned around the periphery of the transporter 100 and may be hydraulically operated.

The transporter 100 may include a pumping unit 109 which may be positioned at the back of the transporter 100 to pump compressed natural gas from the tanks 107 to the user which may be an intermediate storage facility or may be pumped directly into a vehicle of the user. The transporter 100 may include aluminum tubing 105 to connect the pumping unit 109 with the tanks 107, and the pumping unit 109 may be connected to buffer tanks 111 in order to prevent the storage tanks 107 from being drained too quickly.

The transporter 100 may include a generator 121 and associated fuel tank in order to generate electricity for the needs of the transporter 100. The transporter 100 may include caution and scene lights, and antilock breaking system, and air-conditioning system 127 and an aerodynamic nose 125 (tapered).

The transporter 100 is formed with ultra light weight construction including composite panels 103 to cover the transporter 100, aluminum tubing may connect to the tanks 107 and may be reinforced with kevlar, carbon fiber and elbow joints throughout the transporter 100.

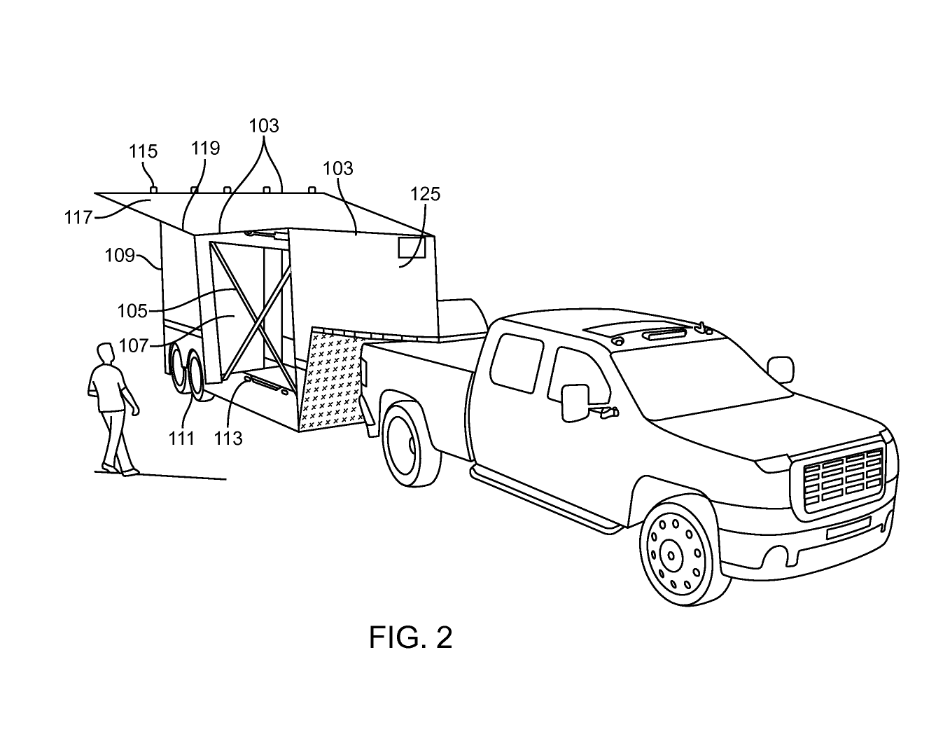

FIG. 2 illustrates a perspective view of the transporter 100 of the present invention, and the transporter 100 may be a trailer being towed by a tractor trailer. The transporter 100 may be formed from composite panels 103 which may include the top panel/roof and may include doors 119 which may form the sides and back of the transporter 100. An additional composite panel 103 may include the front panel of the transporter 100. The transporter 100 may transport compressed natural gas in tube tanks 107 which may be stacked in a frame 113. The tube tanks 107 may be stacked vertically and horizontally in order to provide an efficient packing of the tube tanks 107.

Additionally, the transporter 100 may include emergency lights 115 and cameras 117 which may be used to provide security. Additionally, the transporter 100 may include doors 119 which may be positioned around the periphery of the transporter 100 and may be hydraulically operated.

The transporter 100 may include a pumping unit 109 which may be positioned at the back of the transporter 100 to pump compressed natural gas from the tanks 107 to the user which may be an intermediate storage facility or may be pumped directly into a vehicle of the user. The transporter 100 may include aluminum tubing 105 to connect the pumping unit 109 with the tanks 107, and the pumping unit 109 may be connected to buffer tanks 111 in order to prevent the storage tanks 107 from being drained too quickly.

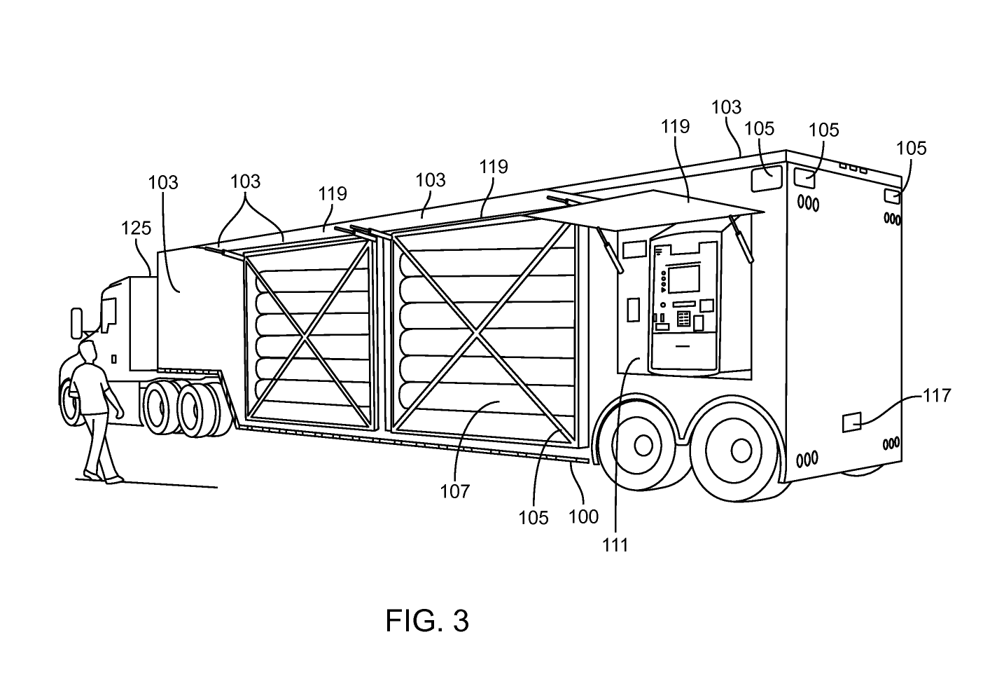

FIG. 3 illustrates a perspective view of the transporter 100 of the present invention, and the transporter 100 may be a trailer being towed by a tractor trailer. The transporter 100 may be formed from composite panels 103 which may include the top panel/roof and may include doors 119 which may form the sides and back of the transporter 100. An additional composite panel 103 may include the front panel of the transporter 100. The transporter 100 may transport compressed natural gas in tube tanks 107 which may be stacked in a frame 113. The tube tanks 107 may be stacked vertically and horizontally in order to provide an efficient packing of the tube tanks 107.

Additionally, the transporter 100 may include emergency lights 115 and cameras 117 which may be used to provide security. Additionally, the transporter 100 may include doors 119 which may be positioned around the periphery of the transporter 100 and may be hydraulically operated.

The transporter 100 may include a pumping unit 109 which may be positioned at the back of the transporter 100 to pump compressed natural gas from the tanks 107 to the user which may be an intermediate storage facility or may be pumped directly into a vehicle of the user. The transporter 100 may include aluminum tubing 105 to connect the pumping unit 109 with the tanks 107, and the pumping unit 109 may be connected to buffer tanks 111 in order to prevent the storage tanks 107 from being drained too quickly.

The transporter 100 may include a generator 121 and associated fuel tank in order to generate electricity for the needs of the transporter 100. The transporter 100 may include caution and scene lights, and antilock breaking system, and air-conditioning system 127 and an aerodynamic nose 125 The transporter 100 is formed with ultra light weight construction including composite panels 103 to cover the transporter 100, aluminum tubing may connect to the tanks 107 and may be reinforced with kevlar, carbon fiber and elbow joints throughout the transporter 100.

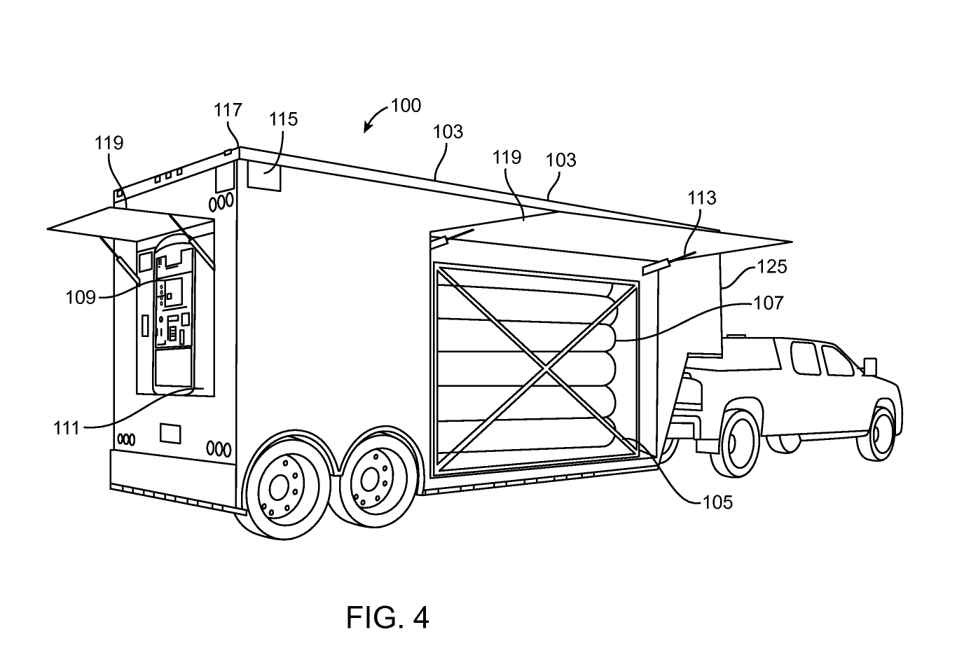

FIG. 4 illustrates a perspective view of the transporter 100 of the present invention, and the transporter 100 may be a trailer being towed by a tractor trailer. The transporter 100 may be formed from composite panels 103 which may include the top panel/roof and may include doors 119 which may form the sides and back of the transporter 100. An additional composite panel 103 may include the front panel of the transporter 100. The transporter 100 may transport compressed natural gas in tube tanks 107 which may be stacked in a frame 113. The tube tanks 107 may be stacked vertically and horizontally in order to provide an efficient packing of the tube tanks 107.

Additionally, the transporter 100 may include emergency lights 115 and cameras 117 which may be used to provide security. Additionally, the transporter 100 may include doors 119 which may be positioned around the periphery of the transporter 100 and may be hydraulically operated.

The transporter 100 may include a pumping unit 109 which may be positioned at the back of the transporter 100 to pump compressed natural gas from the tanks 107 to the user which may be an intermediate storage facility or may be pumped directly into a vehicle of the user. The transporter 100 may include aluminum tubing 105 to connect the pumping unit 109 with the tanks 107, and the pumping unit 109 may be connected to buffer tanks 111 in order to prevent the storage tanks 107 from being drained too quickly.

The transporter 100 may include a generator 121 and associated fuel tank in order to generate electricity for the needs of the transporter 100. The transporter 100 may include caution and scene lights, and antilock breaking system, and air-conditioning system 127 and an aerodynamic nose 125 The transporter 100 is formed with ultra light weight construction including composite panels 103 to cover the transporter 100, aluminum tubing may connect to the tanks 107 and may be reinforced with kevlar, carbon fiber and elbow joints throughout the transporter 100.

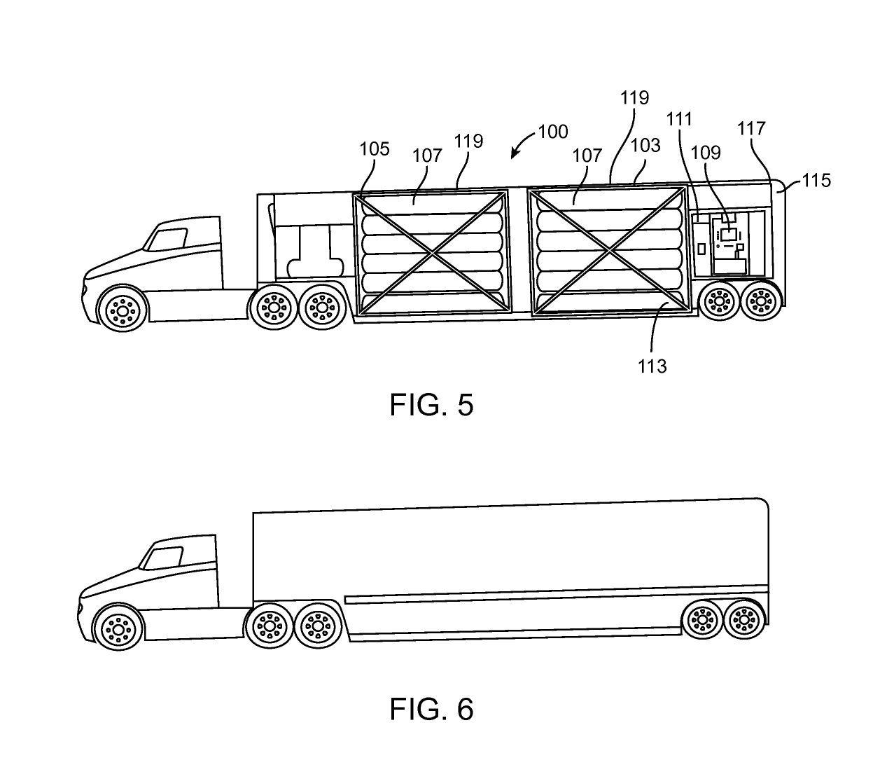

FIG. 5 illustrates a perspective view of the transporter 100 of the present invention, and the transporter 100 may be a trailer being towed by a tractor trailer. The transporter 100 may be formed from composite panels 103 which may include the top panel/roof and may include doors 119 which may form the sides and back of the transporter 100. An additional composite panel 103 may include the front panel of the transporter 100. The transporter 100 may transport compressed natural gas in tube tanks 107 which may be stacked in a frame 113. The tube tanks 107 may be stacked vertically and horizontally in order to provide an efficient packing of the tube tanks 107.

Additionally, the transporter 100 may include emergency lights 115 and cameras 117 which may be used to provide security. Additionally, the transporter 100 may include doors 119 which may be positioned around the periphery of the transporter 100 and may be hydraulically operated.

The transporter 100 may include a pumping unit 109 which may be positioned at the back of the transporter 100 to pump compressed natural gas from the tanks 107 to the user which may be an intermediate storage facility or may be pumped directly into a vehicle of the user. The transporter 100 may include aluminum tubing 105 to connect the pumping unit 109 with the tanks 107, and the pumping unit 109 may be connected to buffer tanks 111 in order to prevent the storage tanks 107 from being drained too quickly.

The transporter 100 may include a generator 121 and associated fuel tank in order to generate electricity for the needs of the transporter 100. The transporter 100 may include caution and scene lights, and antilock breaking system, and air-conditioning system 127 and an aerodynamic nose 125 The transporter 100 is formed with ultra light weight construction including composite panels 103 to cover the transporter 100, aluminum tubing may connect to the tanks 107 and may be reinforced with kevlar, carbon fiber and elbow joints throughout the transporter 100.

The gas tubes/tanks 107 may be a cylinder which may be 10.5′ long 16″ diameter and may be other sizes in order to accommodate different size transporters 100. The gas tubes 107 may weigh 220 Ibs empty and may be filled at 3600 lbs of compressed natural gas CNG. The transporter 100 may include a single rack or may include two racks, each containing 30 tubes (or other appropriate number of tubes) 107 which may be arranged vertically or horizontally with each of the tubes having 800 DGE capacity; each rack×2=1600 DGE's per fleet transporter 100 having a weight less than 42,000 lbs.

The transporter 100 of the present invention may include a pumping unit 109 to pump the compressed natural gas and may include a pair of aluminum V-8 CNG powered unit, and the pumping unit 109 may be 300 HP, each to assist pumping each 30 tube rack at 50% capacity or below. As the level pressure goes down, then pumping unit 109 may be activated to assist our dispensers to fill Customer's fuel tank to around 96% fill rate. The present invention may include a pressure dial to adjust pressure as needed also.

The present invention may be able to dispense at 9-10 gas gallon equivalent GGE per minute as well.

The GGE corresponds to the amount of CNG compressed natural gas containing the same energy content as one gallon of gasoline. The typical conversion rate is 1.25 therms per GGE.

The transporter 100 of the present invention may include buffer tanks 111 which may be 3-6 foot long and may be formed from aluminum acting as buffers to keep charged up with compressed natural gas for next group of customers to keep the pump units 109 from working too hard. The transporter 100 may include a frame 113 to support composite panels 103 which may be positioned on the top and along the side the framework, transaxle, composite panels may weigh approximately 11,000-12,000 lbs, and the fueled tanks may add approximately 30,000 lbs more, making the total weight of approximately 41-42,000 lbs.

The transporter 100 may include aluminum axles and ultra lightweight aluminum wheels.

The transporter 100 may include emergency lighting 115 and may include anti-terrorism release valves on both tank systems which may dispense within 5-10 minutes. The transporter 100 may be tracked by Fleet tracking at home office 24/7 and the transporter 100 may include cameras 117 inside and backside as well. The transporter 100 may be powered down remotely and may use fingerprint technology in order to operate the transporter 100. The transporter 100 may include doors 119 which may swing open or may be hydraulically operated.

The present invention may include tanks 107 which may be a type 4 wrapped in carbon fiber.

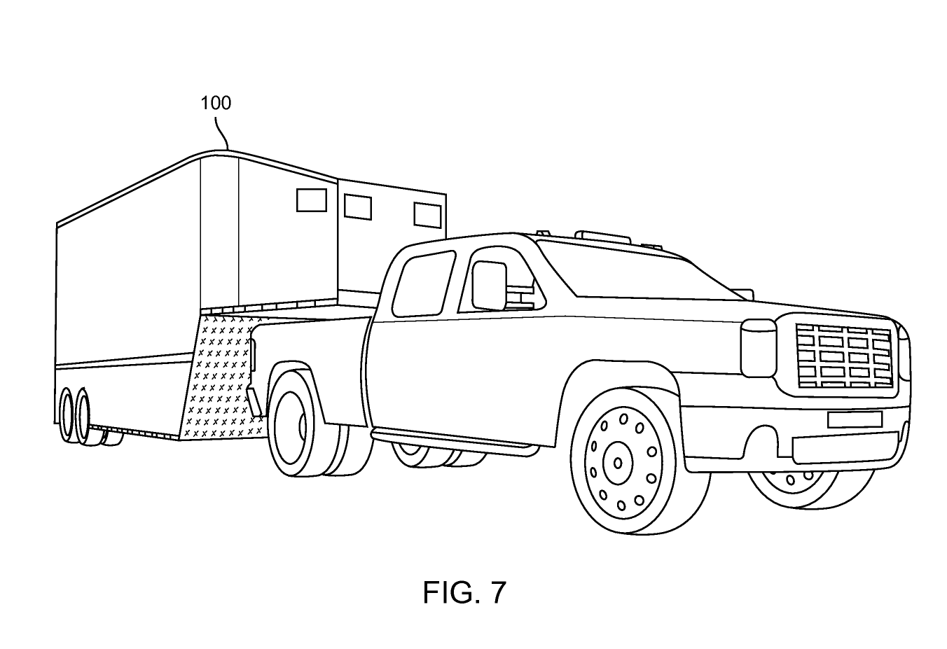

FIGS. 6 and 7 illustrate a perspective view of the transporter 100 which is closed up.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A transporter to transport compressed natural gas, comprising:
a plurality of storage tubes being positioned in a storage rack;
a frame to hold the storage tubes;
at least one composite covering to cover the transporter, and
a pumping unit to pump the compressed natural gas.

2) A transporter to transport compressed natural gas as in claim 1, where in the transporter includes buffer tanks to connect to the pumping unit.

3) A transporter to transport compressed natural gas as in claim 1, wherein the transporter includes emergency lights.

4) A transporter to transport compressed natural gas as in claim 1, wherein the transporter includes at least one camera.

5) A transporter to transport compressed natural gas as in claim 1, wherein the transporter includes a hydraulically operated door.
